(19) United States
(12) Patent Application Publication
(10) Pub. No.: US 2024/0185042 A1
(43) Pub. Date: Jun. 6, 2024

(54) OPERATION METHOD AND APPARATUS BASED ON NEURAL NETWORK

(71) Applicant: CANAAN BRIGHT SIGHT CO., LTD, Beijing (CN)

(72) Inventors: Zhaofei PU, Beijing (CN); Nangeng ZHANG, Beijing (CN)

(21) Appl. No.: 18/553,426

(22) PCT Filed: Jan. 20, 2022
(86) PCT No.: PCT/CN2022/073040

§ 371 Date: Sep. 29, 2023

(30) Foreign Application Priority Data
Apr. 2, 2021 (CN) 202110358538.X

(51) Int. Cl. G06N 3/0464

(52) U.S. Cl. CPC G06N 3/0464

(57) ABSTRACT

In one aspect, an operation method based on a neural network: calculating, according to the sizes of a convolution kernel and an original image, a total number of operation cycles and an image matrix corresponding to each operation cycle; for the image matrix, a plurality of operation units concurrently acquiring the image data and performing a product operation on the image data and pre-stored weight data, to obtain intermediate data; summing the intermediate data to obtain an operation result; and compiling statistics on all the operation results to obtain a target operation result. The overall operation speed is increased in a unit time; the data read logic is simplified; and the bandwidth requirement of a single operation unit for data is reduced. A convolution operation of any size can be performed, and the convolution operation efficiency is improved, thereby increasing the image processing speed.

This application is a national phase of International Patent Application No. PCT/CN2022/073040, filed Jan. 20, 2022, which, in turn, claims priority to Chinese Patent Application No. 202110358538.X, filed on Apr. 2, 2021 and entitled “OPERATION METHOD AND APPARATUS BASED ON NEURAL NETWORK”, the disclosures of both of which are incorporated herein by reference in their entirety.

### TECHNICAL FIELD

The present disclosure relates to the field of deep learning, in particular to a method of and an apparatus for neural network-based operation.

### BACKGROUND

Neural networks involve operations such as convolution, deconvolution, dilated convolution, and matrix multiplication, and what these operations have in common is that their basic operations are all multiply-add operations. Therefore, a multiply-add array is needed to support these operations. A tensor processing unit (TPU) is a multiply-add array chip customized for machine learning, which can reduce power consumption and accelerate operations. The TPU includes: a matrix processor configured to load a convolutional neural network and handle a large number of multiply-add operations for the convolutional neural network; a unified buffer, i.e., register; and an activation unit which has a hardwired activation function. Currently, when performing an operation, a reading module is usually used to read data from an external storage, and then send the data to a matrix multiplication unit for performing the operation. However, the data after being read by the reading module needs to be rearranged in order to meet operation requirements of the matrix multiplication unit. This reading manner involving rearrangement leads to a rather complex reading logic and cumbersome overall operation steps, which may slow down the operation and in turn lead to a slower processing in scenarios such as image processing tasks and speech processing tasks.

### SUMMARY

Embodiments of the present disclosure provide a method of and an apparatus for neural network-based operation to solve the problems in the related art, and the technical solutions thereof are as follows.

According to a first aspect, embodiments of the present disclosure provide a method of neural network-based operation, including:

acquiring an original image, and calculating the total number of operation cycles and an image matrix corresponding to each of the operation cycles from dimensions of a convolution kernel and dimensions of the original image, the image matrix including image data in multiple rows and columns;

acquiring, for the image matrix corresponding to each of the operation cycles, the image data by a plurality of operation units in parallel according to an operation instruction, and performing multiplication operations on pre-stored weight data and the image data to acquire intermediate data;

summing intermediate data output by the plurality of operation units to acquire an operation result corresponding to each of the operation cycles; and

gathering all operation results for the total number of operation cycles to acquire a target operation result.

In an embodiment, the method further includes:

determining a weight matrix based on the dimensions of the convolution kernel, where the weight matrix includes weight data in multiple rows and columns, and the convolution kernel has a height equal to the number of rows of the weight matrix and has a width equal to the number of columns of the weight matrix; and

pre-storing by the plurality of operation units the weight data in corresponding rows of the weight matrix respectively.

In an embodiment, acquiring, for the image matrix corresponding to each of the operation cycles, the image data by the plurality of operation units in parallel according to the operation instruction includes:

acquiring, for the image matrix corresponding to each of the operation cycles, the image data in corresponding rows of the image matrix according to the operation instruction by the plurality of operation units respectively.

In an embodiment, acquiring, for the image matrix corresponding to each of the operation cycles, the image data by the plurality of operation units in parallel according to the operation instruction includes:

changing, for the image matrix corresponding to a current operation cycle, one element of each row of the image data, with the changed image matrix serving as an image matrix corresponding to a next operation cycle; and

acquiring, for the image matrix corresponding to the next operation cycle, changed image data in corresponding rows by the plurality of operation units, respectively.

In an embodiment, the plurality of operation units form operation unit groups, and the dimensions of the convolution kernel include the number of input channels which is same as the number of the operation unit groups.

According to a second aspect, embodiments of the present disclosure provide an apparatus for neural network-based operation, including:

an image matrix calculating module configured to acquire an original image, and calculate the total number of operation cycles and an image matrix corresponding to each of the operation cycles from dimensions of a convolution kernel and dimensions of the original image, the image matrix including image data in multiple rows and columns;

a multiplication operation module configured to acquire, for the image matrix corresponding to each of the operation cycles, the image data by a plurality of operation units in parallel according to an operation instruction, and perform multiplication operations on pre-stored weight data and the image data to acquire intermediate data;

a summation operation module configured to sum intermediate data output by the plurality of operation units to acquire an operation result corresponding to each of the operation cycles; and

a target operation result generating module configured to gather all operation results for the total number of operation cycles to acquire a target operation result.

In an embodiment, the apparatus further includes:

a weight matrix determining module configured to determine a weight matrix based on the dimensions of the convolution kernel, where the weight matrix includes weight data in multiple rows and columns, and the convolution kernel has a height equal to the number of rows of the weight matrix and has a width equal to the number of columns of the weight matrix; and

a weight data storing module configured to pre-store by the plurality of operation units the weight data in corresponding rows of the weight matrix respectively.

In an embodiment, the multiplication operation module includes:

a first data acquiring submodule configured to acquire, for the image matrix corresponding to each of the operation cycles, the image data in corresponding rows of the image matrix according to the operation instruction by the plurality of operation units respectively.

In an embodiment, the multiplication operation module includes:

a data changing submodule configured to change, for the image matrix corresponding to a current operation cycle, one element of the each row of the image data, with the changed image matrix serving as an image matrix corresponding to a next operation cycle; and

a second data acquiring submodule configured to acquire, for the image matrix corresponding to the next operation cycle, changed image data in corresponding rows by the plurality of operation units, respectively.

In an embodiment, the plurality of operation units form operation unit groups, and the dimensions of the convolution kernel include the number of input channels which is same as the number of the operation unit groups.

According to a third aspect, provided is an electronic device, which includes:

at least one processor and a memory communicatively connected to the at least one processor;

where the memory has stored thereon instructions executable by the at least one processor, the instructions, when executed by the at least one processor, causes the at least one processor to perform the method according to any one of the aforesaid embodiments.

According to a fourth aspect, provided is a non-transitory computer readable storage medium having computer instructions stored thereon, where the computer instructions are configured to cause a computer to perform the method according to any one of the aforesaid embodiments.

An embodiment of the present disclosure has the following advantages or beneficial effects. For the image matrix corresponding to each of the operation cycles, a plurality of operation units acquire the image data in parallel and perform their respective multiplication operations in parallel, that is, perform multiplication operations on the pre-stored weight data and the image data to acquire intermediate data; sum intermediate data output by the plurality of operation units to acquire an operation result corresponding to each of the operation cycles; and gather all operation results for the total number of operation cycles to acquire a target operation result. As a result, the method can solve problems of a complex reading logic and a poor operation speed due to the necessity to rearrange the image data when using one operation unit for a convolution operation. Since the multiplication operations are performed in parallel by a plurality of operations units, the overall operation speed per unit time can be increased, the data reading logic can be simplified, and the data bandwidth requirement for a single operation unit can be reduced. Further, the convolution operation of any size can be performed to achieve the effect of accelerating the convolution operation, or matrix multiplication operation of any size can be performed to achieve the effect of accelerating the matrix multiplication operation, thereby improving the operation efficiency. In addition, the execution efficiency can be improved without adding any hardware resource, and the final display image can be acquired by processing the convolution operation only once, which improves the image processing speed.

Other effects of the aforesaid optional manners will be described below in conjunction with specific embodiments.

### BRIEF DESCRIPTION OF THE DRAWINGS

The drawings are intended to facilitate understanding of the disclosure, and do not constitute a limitation to the present disclosure. In the drawings:

FIG. 1 is a schematic diagram of a method for optimizing convolution operations with Im2col functions according to the prior art;

FIG. 2 is a schematic diagram of a method of neural network-based operation according to an embodiment of the present disclosure;

FIG. 3 is a schematic structural diagram of an operation module (PU) according to an embodiment of the present disclosure;

FIG. 4 is a schematic diagram of an internal structure of an operation unit (PE) according to an embodiment of the present disclosure;

FIG. 5 is a schematic diagram of a scenario for a convolution operation of 1*3 according to an embodiment of the present disclosure;

FIG. 6 is a block structural diagram of an apparatus for neural network-based operation according to an embodiment of the present disclosure; and

FIG. 7 is a block diagram of an electronic device for implementing the method of neural network-based operation according to embodiments of the present disclosure.

### DETAILED DESCRIPTION

The exemplary embodiments of the present disclosure will be described below in conjunction with the accompanying drawings, which include various details of the embodiments of the present disclosure to aid in understanding, and shall be considered merely exemplary. Accordingly, one of ordinary skill in the art should recognize that various changes and modifications can be made to the embodiments described herein without departing from the scope and spirit of the present disclosure. For the sake of clarity and brevity, descriptions of well-known features and structures have been omitted from the following description.

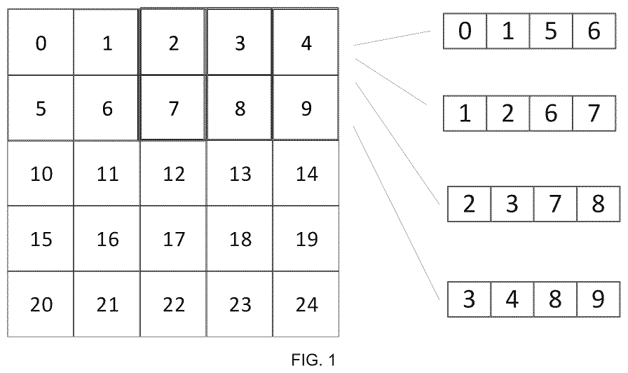

In the prior art, an Im2col function is generally adopted to optimize a convolution operation when learning and training of a convolutional neural network. What Im2col does is to expand each small window to be processed by the convolution kernel into one row (column) of a new matrix, with the number of rows (columns) of the new matrix being the number of convolution operations (sliding times of the convolution kernel) required for an input image. For the sake of calculation, the original input image data shall be rearranged before being sent to the operation unit for performing the matrix multiplication operation. As shown in FIG. 1, it is assumed that a convolution kernel has a size of 2*2 and an input image has a size of 5*5. the data of a first pixel point is conventionally read by an additional reading module. When reading, the data is read in jumps rather than in the stored order of 123 . . . 24. For example, the data of a first pixel point is read as 0156, the data of a second pixel point is read as 1267, the data of a third pixel point is read as 2378 . . . and so on, such that all the data of the input image is read and rearranged into rows in the order they are read. The rearranged data is then sent to a single operation unit in sequence for the matrix multiplication operation, thereby outputting the operation result. When the convolution operation is performed by a single operation unit, the reading manner involving rearrangement as described above leads to a rather complex reading logic, and multiple operations are required for obtaining the final, which causes the overall operation steps to be cumbersome and slows down the operation, which in turn leads to a slower image processing speed.

In order to solve the technical problems, embodiments provide a method of neural network-based operation, which is applicable to an operation module (e.g., PU (Process Unit)). The array of operation units (e.g., PE (Process Element)) serves as a main computation unit inside the operation module, and its size determines the computation capacity of the operation module. A plurality of operation units may form an array of operation units, and the array of operation units may be a matrix processor. The array of operation units may work based on operation instructions sent by a control logic module (ctrl), such that operations involving multiply-add operations in the neural network, such as the matrix multiplication, convolution, deconvolution, and dilated convolution can be implemented in the operation module.

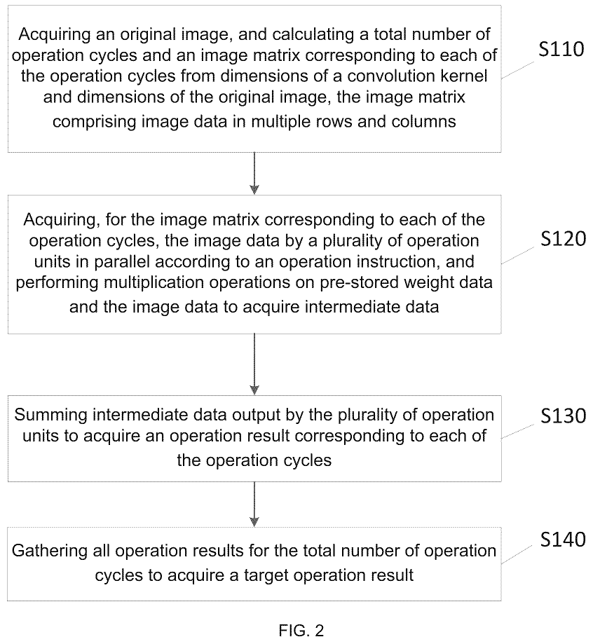

As shown in FIG. 2, the method of neural network-based operation includes the following steps S110 to S140.

Step S110: an original image is acquired, and the total number of operation cycles and an image matrix corresponding to each of the operation cycles are calculated from dimensions of a convolution kernel and dimensions of the original image, the image matrix including image data in multiple rows and columns.

Step S120: for the image matrix corresponding to each of the operation cycles, the image data is acquired in parallel by a plurality of operation units according to an operation instruction, and multiplication operations are performed on pre-stored weight data and the image data to acquire intermediate data.

Step S130: intermediate data output by the plurality of operation units is summed to acquire an operation result corresponding to each of the operation cycles.

Step S140: all operation results for the total number of operation cycles are gathered to acquire a target operation result.

In one example, for task scenarios such as image recognition, image classification, speech recognition and speech classification, features of the original image or original speech can be extracted by operations of the convolutional neural network (CNN). The data of the original image, the data of the original speech and the like may serve as an input feature map for extracting feature data via the convolutional neural network. The feature data may include color feature data, texture feature data, shape feature data, spatial feature data and the like of the image, or include sound intensity feature data, volume feature data, pitch feature data and the like, for serving as an output feature map. The dimensions of the original image may include the values of batch, the height, the width, and the number of channels (i.e., in depth) of the image. The dimensions of the convolution kernel may include the values of the height, the width, the number of input channels (i.e., in depth), and the number of output channels (i.e., out depth) of the convolution kernel. Then, a weight matrix is determined based on the dimensions of the convolution kernel, and the weight matrix includes weight data in multiple rows and columns. The total number of operation cycles and the image matrix corresponding to each of the operation cycles are calculated from dimensions of the convolution kernel and dimensions of the original image, and the image matrix includes image data in multiple rows and columns. The convolution kernel performs a sliding window convolution operation on the original image, with each sliding window convolution operation taken as one operation cycle, until the end of sliding in the input feature map. The number of sliding times is calculated as the total number of operation cycles. Therefore, the total number of operation cycles is determined by both the dimensions of the convolution kernel and the dimensions of the original image.

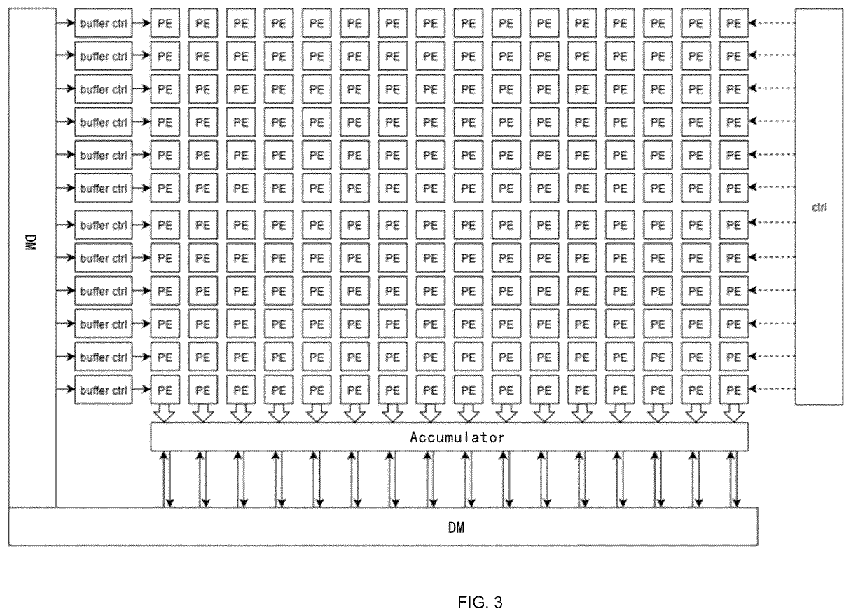

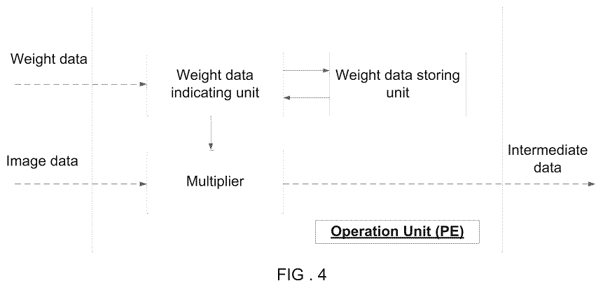

In one example, as shown in FIG. 3, the operation module may include an operation unit array of 24 rows and 32 columns to perform the multiply-add operations involved in the neural network. A data manager (DM) provides the operation module with the data of the original image (input feature map) and calculates the total number of operation cycles and the image matrix corresponding to each of the operation cycles from the dimensions of the convolution kernel and the dimensions of the original image. The image matrix includes image data in multiple rows and columns. The data manager also writes the target operation result (output feature map). The image matrix corresponding to each of the operation cycles is stored in a buffer control module (buffer ctrl) for sharing with the operation units in each row. A control logic module (ctrl) is provided to send operation instructions to each operation unit, and the operation instructions include a current operation cycle. As shown in FIG. 4, an internal structure diagram of an operation unit is provided for implementing the operation method according to this embodiment. The operation unit includes a weight data indicating unit, a weight data storing unit, and a multiplier. A storage space of the weight data storing unit may be configured according to the actual situation and may for example be 8*16 bits and the like.

The specific operation process includes following procedures. Firstly, a plurality of operation units arranged in one column pre-store the weight data in the corresponding rows of the weight matrix respectively, where the number of rows of the weight matrix is same as and in one-to-one correspondence with the number of operation units in one column. In each operation unit, the weight data indicating unit instructs said each operation unit to pre-store the corresponding weight data in the weight data storing unit based on the dimensions of the convolution kernel. Secondly, a plurality of operation units arranged in one column may acquire the operation instructions that include a first operation cycle. During execution of the operation instructions, the plurality of operation units arranged in one column in parallel acquire, for the image matrix corresponding to the first operation cycle, the image data in the corresponding rows of the image matrix respectively according to the operation instructions. In each operation unit, the multiplier performs the multiplication operation based on the acquired image data and the pre-stored weight data to acquire intermediate data, and the intermediate data as output is sent to the accumulator. The accumulator sums the intermediate data calculated by the operation units in each column to obtain the operation result corresponding to the first operation cycle, and then sends the operation result to the data manager for storage. Finally, the operation cycles are accumulated, and if the cumulative number of the operation cycles does not reach the total number of operation cycles, the operation of the next operation cycle is carried out. The specific process is similar to the operation of the first operation cycle, and the operation is executed cyclically until the cumulative number of the operation cycles reaches the total number of operation cycles. If the cumulative number of the operation cycles reaches the total number, the operation results as acquired from all the operation cycles are sent to a result storing module of the data manager. An output controlling module of the data manager extracts a plurality of operation results (output feature map) from the result storing module and then outputs the operation results.

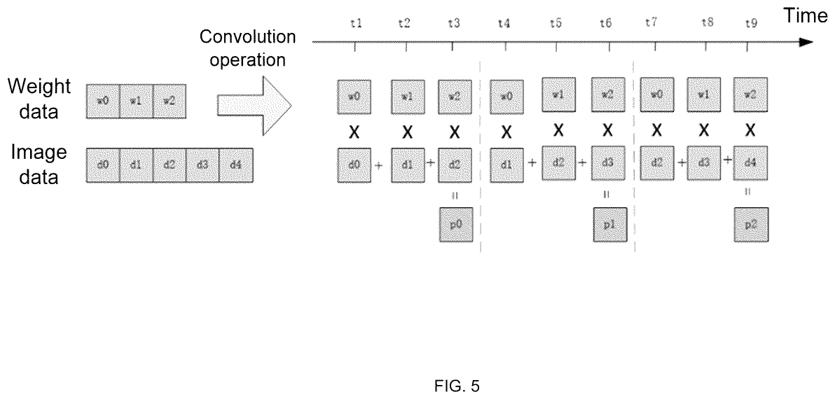

In an embodiment, an operation unit PE0 is adopted as shown in FIG. 5 to perform a convolution operation of 1*3. The weight matrix is a 1*3 matrix, with the weight data including w0, w1, and w2, which are pre-stored in the weight data storing unit of the operation unit PE0. The input matrix corresponding to the input feature map of 1*5 is a 1*5 input matrix, and the input image data in the input matrix includes d0, d1, d2, d3, and d4. The convolution kernel of 1*3 performs a sliding window operation on the input feature map of 1*5 with the total number of operation cycles being 3. The image matrix corresponding to the operation cycle t1-t3 is [d0, d1, d2], the image matrix corresponding to the operation cycle t4-t6 is [d1, d2, d3], and the image matrix corresponding to the operation cycle t7-19 is [d2, d3, d4]. The operation unit PE0 acquires the operation instruction, and acquires d0, d1, and d2 in the operation cycle t1-t3 according to the operation instruction. Then, the image data d0, d1, and d2 are multiplied with the corresponding weight data w0, w1, and w2 by the multiplier of the operation unit PE0 to acquire the intermediate data d0*w0, d1*w1, and d2*w2. Afterwards, the intermediate data are sent to the accumulator and accumulated as d0*w0+d1*w1+d2*w2=P0, such that the accumulator outputs the operation result of the operation cycle t1-t3 as P0. Similarly, the accumulator outputs the operation result as d1*w0+d2*w1+d3*w2=P1 in the operation cycle t4-t6, and outputs the operation result as d2*w0+d3*w1+d4*w2=P2 in the operation cycle t7-19. All the operation results for the total number of operation cycles are gathered to acquire a target operation result, which means that the output feature map includes the operation results P0, P1 and P2.

In another embodiment, operation units PE0 to PE2 in one column of the array of operation units are adopted to perform the convolution operation of 3*3. For the convolution operation of 3*3, the weight matrix is a 3*3 matrix as follows:

$$[ \begin{matrix}w 0 & w 1 & w 2 \\ w 3 & w 4 & w 5 \\ w 6 & w 7 & w 8\end{matrix} ]$$

The weight data includes w0 to w8. The weight data indicating unit in PE0 instructs the PE0 to pre-store w0 to w2 into the weight storing unit of PE0, the weight data indicating unit in PE1 instructs the PE1 to pre-store w3 to w5 into the weight storing unit of PE1, and the weight data indicating unit in PE2 instructs the PE2 to pre-store w6 to w8 into the weight storing unit of PE2. The input matrix determined from the input feature map of 5*3 is as follows:

$$[ \begin{matrix}d 0 & d 1 ⋯ & d 4 \\ ⋮ & ⋱ & ⋮ \\ d 10 & ⋯ & d 14\end{matrix} ]$$

The convolution kernel of 3*3 performs the sliding window operation on the input feature map of 5*3, with the total number of operation cycles being 3. The image matrix corresponding to each operation cycle is as follows:

$$[ \begin{matrix}d 0 & d 1 & d 2 \\ d 5 & d 6 & d 7 \\ d 10 & d 11 & d 12\end{matrix} ] , [ \begin{matrix}d 1 & d 2 & d 3 \\ d 6 & d 7 & d 8 \\ d 11 & d 12 & d 13\end{matrix} ] , [ \begin{matrix}d 2 & d 3 & d 4 \\ d 7 & d 8 & d 9 \\ d 12 & d 13 & d 14\end{matrix} ]$$

In the first operation cycle, the operation unit PE0 acquires image data d0, d1, d2 in the first row and multiplies them with the pre-stored weight data w0, w1, w2 to acquire the intermediate data d0*w0, d1*w1, d2*w2; then, the intermediate data are sent to the accumulator for accumulation, and the accumulator outputs the operation result as T0=d0*w0+d1*w1+d2*w2 (referring to the embodiment shown in FIG. 4 for the specific process). The operation unit PE1 acquires image data d5, d6, d7 in the second row and multiplies them with the pre-stored weight data w3, w4, w5 respectively to acquire the intermediate data; then, the intermediate data are sent to the accumulator for accumulation, and the accumulator outputs the operation result as T1=d5*w3+d6*w4+d7*w5. The operation unit PE2 acquires the image data d10, d11, d12 in the third row, and multiplies them with the pre-stored weight data w6, w7, w8 to acquire the intermediate data; then, the intermediate data are sent to the accumulator for accumulation, and the accumulator outputs the operation result as T2=d10*w6+d11*w7+d12*w8.

In the second operation cycle, the operation unit PE0 acquires feature data d1, d2, d3 in the first row and multiplies them with the pre-stored weight data w0, w1, w2 respectively to acquire the intermediate data; then, the intermediate data are sent to the accumulator for accumulation, and the accumulator outputs the operation result as T0′=d1*w0+d2*w1+d3*w2 (referring to the embodiment shown in FIG. 4 for the specific process). The operation unit PE1 acquires image data d6, d7, d8 in the second row and multiplies them with the pre-stored weight data w3, w4, w5 respectively to acquire the intermediate data; then, the intermediate data are sent to the accumulator for accumulation, and the accumulator outputs the operation result as T1′=d6*w3+d7*w4+d8*w5. The operation unit PE2 acquires the image data d11, d12, d13 in the third row, and multiplies them with the weight data w6, w7, w8 to acquire the intermediate data; then, the intermediate data are sent to the accumulator for accumulation, and the accumulator outputs the operation result as T2′=d11*w6+d12*w7+d13*w8. In the third operation cycle, for the operation process of operations units PE0 to PE2, refer to the process of the first operation cycle and the second operation cycle as described above; and similarly, the operation results output by the accumulator include T0″=d2*w0+d3″w1+d4*w2, T1″=d7*w3+d8″w4+d9*w5, and T2″=d12*w6+d13*w7+d14*w8. Then, all the operation results for the total number of operation cycles are gathered to acquire the target operation result, which means that the output feature maps include: T0, T1, T2; T0′, T1′, T2′; and T0″, T1″, T2″. It should be noted that the operation units PE0, PE1 and PE2 perform the respective multiplication operations in parallel in each operation cycle, which improves the operation efficiency and saves the operation time. Of course, the number and arrangement of operation units can be adjusted adaptively according to the actual situation.

According to this embodiment, for the image matrix corresponding to each of the operation cycles, a plurality of operation units acquire the image data in parallel and perform their respective multiplication operations in parallel, that is, perform multiplication operations on the pre-stored weight data and the image data to acquire intermediate data; sum the intermediate data output by the plurality of operation units to acquire an operation result corresponding to each of the operation cycles; and gather all operation results for the total number of operation cycles to acquire a target operation result. As a result, the method can solve problems of a complex reading logic and a poor operation speed due to the necessity to rearrange the image data when using one operation unit for a convolution operation. Since the multiplication operations are performed in parallel by a plurality of operations units, the overall operation speed per unit time can be increased, the data reading logic can be simplified, and the data bandwidth requirement for a single operation unit can be reduced. Further, the convolution operation of any size can be performed to achieve the effect of accelerating the convolution operation, or matrix multiplication operation of any size can be performed to achieve the effect of accelerating the matrix multiplication operation, thereby improving the operation efficiency. In addition, the execution efficiency can be improved without adding any hardware resource, and the final display image can be acquired by processing the convolution operation only once, which improves the image processing speed.

In an embodiment, the method further includes following steps S121 and S122.

Step S121: a weight matrix is determined based on the dimensions of the convolution kernel. The weight matrix includes weight data in multiple rows and columns, and the convolution kernel has a height equal to the number of rows of the weight matrix and has a width equal to the number of columns of the weight matrix.

Step S122: the weight data in corresponding rows of the weight matrix is pre-stored by the plurality of operation units respectively.

In one example, the operation unit PE0 performs a convolution operation of 1*3. Then, the weight matrix is a 1*3 matrix, and the weight data includes w0, w1, and w2. For the convolution operation of 3*3, the weight matrix is a 3*3 matrix; similarly, the convolution operation of any size can be performed, which expands the operation range. Since a weight data storing unit is provided in the operation unit to pre-store the weight data, each operation unit does not need to read the weight data repeatedly when performing the convolution operation, which simplifies the reading logic, improves the operation speed and saves the operation resources.

In an embodiment, the step S120 of acquiring, for the image matrix corresponding to each of the operation cycles, the image data by the plurality of operation units in parallel according to the operation instruction includes a step S121.

Step S121: for the image matrix corresponding to each of the operation cycles, the image data in corresponding rows of the image matrix is acquired by the plurality of operation units respectively according to the operation instruction.

In an example, during the convolution operation of 3*3 as performed by a column of operation units PE0 to PE2 in the array of operation units, the operation units PE0, PE1 and PE2 are arranged in one column; the operation instruction includes a current operation cycle; and if the current operation cycle is the first operation cycle, the operation unit PE0 acquires the image data d0, d1, d2 in the first row, the operation unit PE1 acquires the image data d5, d6, d7 in the second row, and the operation unit PE2 acquires the image data d10, d11, d12 in the third row. Similarly, the convolution operation can be performed on the input feature map of any size, which expands the operation range. In addition, since the plurality of operation units acquire image data of corresponding rows in parallel and perform the convolution operation simultaneously, the operation can be accelerated, and the operation efficiency can be improved.

In an embodiment, the step S120 of acquiring, for the image matrix corresponding to each of the operation cycles, the image data by the plurality of operation units in parallel according to the operation instruction includes steps S122 and S123.

Step S122: for the image matrix corresponding to a current operation cycle, one element of each row of the image data is changed, and the changed image matrix serves as an image matrix corresponding to a next operation cycle.

Step S123: for the image matrix corresponding to the next operation cycle, changed image data in corresponding rows is acquired by the plurality of operation units respectively.

In an example, when the next operation cycle is performed after completion of the previous operation cycle, the data manager changes the image data and only needs to change one of the data. For example, during the convolution operation of 3*3 as performed by operation units PE0 to PE2 in one column of the array of operation units, the operation unit PE0 acquires the image data d0, d1, d2 in the first row within the first operation cycle, the operation unit PE0 acquires the image data d1, d2, d3 in the first row within the second operation cycle, and the operation unit PE0 acquires the image data d2, d3, d4 in the first row within the third operation cycle. In the three operation cycles, only one of the data needs to be changed by the data manager. For example, after the first operation cycle, the image data d0 in the first row is changed to d3, and the d3 as changed is input to the operation unit PE0 for the convolution operation in the second operation cycle; and the operation unit PE0 does not need to read d1 and d2 again. After the second operation cycle, the image data d1 in the first row is changed to d4, and the d4 as changed is input to the operation unit PE0 for the convolution operation in the third operation cycle; and the operation unit PE0 does not need to read d2 and d3 again. In this way, the duplicate reading of data can be effectively avoided, the operation speed can be increased, and the operation resources can be saved.

In an embodiment, the plurality of operation units form operation unit groups, and the dimensions of the convolution kernel include the number of input channels which is same as the number of the operation unit groups.

In an example, for the convolution operation of 3*3, three operation units PE0 to PE2 in one column form one operation unit group, and the output feature map calculated by the one operation unit group constitutes one input channel. Since the height of the array of operation units in one operation module PU is 24, 8 operation unit groups (with each operation unit group including three operation units arranged in the column) can be adopted simultaneously to perform the operation, such that the output feature maps as acquired constitute 8 input channels. That is, for one operation module PU (with an array of 24 rows and 32 columns of operation units), the input feature map of 8 input channels can be processed for the convolution operation of 3*3. Since the number of channels is usually a power of 2, the number of output channels as determined in this embodiment is 32.

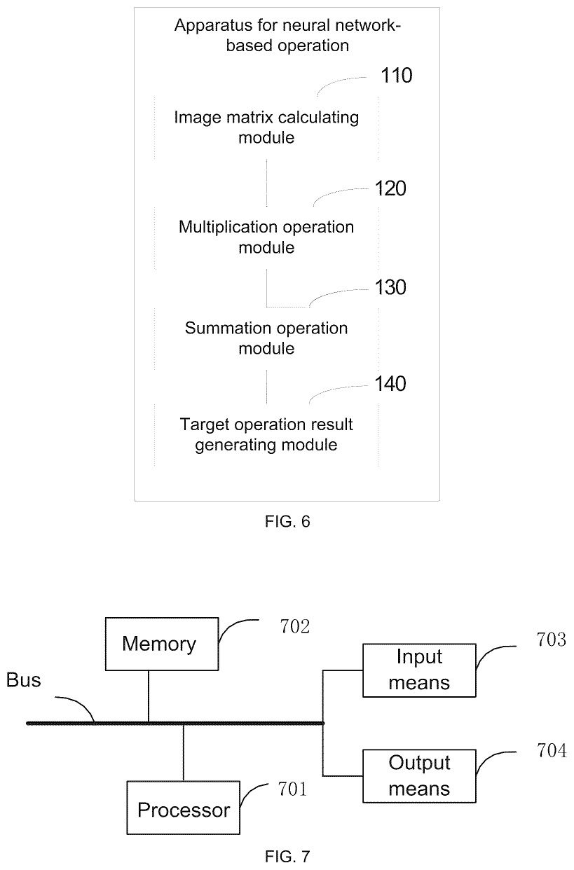

According to another embodiment, as shown in FIG. 6, provided is an apparatus for neural network-based operation, which includes:

an image matrix calculating module 110 configured to acquire an original image, and calculate the total number of operation cycles and an image matrix corresponding to each of the operation cycles from dimensions of a convolution kernel and dimensions of the original image, the image matrix including image data in multiple rows and columns;

a multiplication operation module 120 configured to acquire, for the image matrix corresponding to each of the operation cycles, the image data by a plurality of operation units in parallel according to an operation instruction, and perform multiplication operations on pre-stored weight data and the image data to acquire intermediate data;

a summation operation module 130 configured to sum the intermediate data output by the plurality of operation units to acquire an operation result corresponding to each of the operation cycles; and

a target operation result generating module 140 configured to gather all operation results for the total number of operation cycles to acquire a target operation result.

In an embodiment, the apparatus further includes:

a weight matrix determining module configured to determine a weight matrix based on the dimensions of the convolution kernel, where the weight matrix includes weight data in multiple rows and columns, and the convolution kernel has a height equal to the number of rows of the weight matrix and has a width equal to the number of columns of the weight matrix; and

a weight data storing module configured to pre-store by the plurality of operation units the weight data in corresponding rows of the weight matrix respectively.

In an embodiment, the multiplication operation module includes:

a first data acquiring submodule configured to acquire, for the image matrix corresponding to each of the operation cycles, the image data in corresponding rows of the image matrix according to the operation instruction by the plurality of operation units respectively.

In an embodiment, the multiplication operation module includes:

a data changing submodule configured to change, for the image matrix corresponding to a current operation cycle, one element of each row of the image data, with the changed image matrix serving as an image matrix corresponding to a next operation cycle; and

a second data acquiring submodule configured to acquire, for the image matrix corresponding to the next operation cycle, changed image data in corresponding rows by the plurality of operation units, respectively.

In an embodiment, the plurality of operation units form operation unit groups, and the dimensions of the convolution kernel include the number of input channels which is same as the number of the operation unit groups.

The functions of each module in the apparatus according to embodiments of the present disclosure may be found in the corresponding descriptions of the method and will not be repeated herein.

According to embodiments of the present disclosure, the present disclosure further provides an electronic device and a readable storage medium.

As shown in FIG. 7, it is a block diagram of an electronic device for implementing the method of neural network-based operation according to embodiments of the present disclosure. The electronic device is intended to denote various forms of digital computers, such as laptops, desktop computers, workstations, personal digital assistants, servers, blade servers, mainframe computers, and other suitable computers. The electronic device may also denote various forms of mobile devices, such as personal digital assistants, cellular phones, smart phones, wearable devices, and other similar computing devices. The components, the connection and relationship therebetween, and the functions thereof are shown herein as examples only and are not intended to limit the implementations of the present disclosure as described and/or claimed herein.

As shown in FIG. 7, the electronic device includes: one or more processors 701. a memory 702, and interfaces for connecting the components, including a high speed interface and a low speed interface. The components are interconnected with different buses and may be mounted on a common motherboard or mounted in other fashions according to needs. The processor may process instructions executed within the electronic device, and the instructions may include instructions stored in or on a memory for displaying graphical information of a graphical user interface (GUI) on an external input/output means (e.g., a display device coupled to an interface). In other embodiments, a plurality of processors and/or a plurality of buses may be adopted with a plurality of memories, if desired. Similarly, a plurality of electronic devices may be connected thereto, with each device providing some of the necessary operations (e.g., as a server array, a group of blade servers, or a multiprocessor system). FIG. 7 is illustrated by taking one processor 701 as an example.

The memory 702 is the non-transitory computer readable storage medium according to the present disclosure. The memory has stored thereon instructions executable by at least one processor to cause the at least one processor to execute the method of neural network-based operation according to the present disclosure. The non-transitory computer readable storage medium of the present disclosure has stored thereon computer instructions that cause the computer to execute the method of neural network-based operation according to the present disclosure.

The memory 702, as a non-transitory computer readable storage medium, may be configured to store non-transitory software programs, non-transitory computer executable programs, and modules, such as the program instructions/modules corresponding to the method of neural network-based operation according to the present disclosure. The processor 701 performs various functional applications of the server and data processing by running non-transitory software programs, instructions, and modules stored in the memory 702, which means to implement the method of neural network-based operation according to aforesaid embodiments of the present disclosure.

The memory 702 may include a program storing area and a data storing area. The program storing area may store an operating system, and an application program required for at least one function, and the data storing area may store data created under the use of an electronic device for the method of neural network-based operation. In addition, the memory 702 may include a high-speed random access memory and a non-transitory memory, such as at least one disk memory device, a flash memory device, or other non-transitory solid-state memory device. In some embodiments, the memory 702 optionally includes a memory disposed remotely relative to the processor 701, and such a remote memory may be connected to the electronic device via a network. Examples of the network include, but are not limited to, the Internet, a corporate intranet, a local area network, a mobile communication network, and a combination thereof.

The electronic device may further include an input means 703 and an output means 704. The processor 701, the memory 702, the input means 703 and the output means 704 may be connected via a bus or other fashions, and FIG. 7 is illustrated by taking the connection via a bus as an example.

The input means 703 may receive input numeric or character information, and generate the key signal input related to user settings and functional control of the electronic device; and the input means may for example be a touch screen, keypad, mouse, trackpad, touchpad, indicator stick, one or more mouse buttons, trackball, joystick, and other input means. The output means 704 may include a display device, an auxiliary lighting device (e.g., LED), a haptic feedback device (e.g., a vibration motor), and the like. The display device may include, but is not limited to, a liquid crystal display (LCD), a light emitting diode (LED) display, and a plasma display. In some embodiments, the display device may be a touch screen.

The various embodiments of the system and technique described herein may be implemented in a digital electronic circuit system, an integrated circuit system, an application specific integrated circuit (ASIC), a computer hardware, a firmware, a software, and/or a combination thereof. The various embodiments may include the implementation in one or more computer programs that may be executed and/or interpreted on a programmable system including at least one programmable processor. The programmable processor may be a dedicated or general-purpose programmable processor that may receive data and instructions from a storage system, at least one input means, and at least one output means, and transfer data and instructions to the storage system, the at least one input means, and the at least one output means.

The computing programs (also referred to as programs, software, software applications, or code) include machine instructions for a programmable processor and may be implemented with a high-level procedural and/or object-oriented programming language, and/or an assembly/machine language. As used herein, the terms “machine readable medium” and “computer readable medium” refer to any computer program product, device, and/or apparatus (e.g., disk, CD, memory, programmable logic device (PLD)) adopted to provide machine instructions and/or data to a programmable processor, which includes a machine readable medium that receives machine instructions as machine-readable signals. The term “machine-readable signal” refers to any signal adopted to provide machine instructions and/or data to a programmable processor.

To provide interaction with a user, the system and technique described herein may be implemented on a computer. The computer has a display device (e.g., a cathode ray tube (CRT) or liquid crystal display (LCD) monitor) for displaying information to the user, and a keyboard and pointing device (e.g., a mouse or trackball) through which the user can provide input to the computer. Other types of devices may also be adopted to provide interaction with the user. For example, the feedback provided to the user may be any form of sensory feedback (e.g., visual feedback, auditory feedback, or haptic feedback), and the input from the user may be received in any form (including acoustic input, voice input, or, haptic input).

The system and technique described herein may be implemented in a computing system including a backend component (e.g., as a data server), or a computing system including a middleware component (e.g., an application server), or a computing system including a frontend component (e.g., a user computer having a graphical user interface or a web browser through which a user may interact with implementations of the system and technique described herein), or a computing system including any combination of the backend component, the middleware component, or the frontend component. The components of a system may be interconnected by the digital data communication (e.g., a communication network) in any form or medium. Examples of the communication network include a local area network (LAN), a wide area network (WAN), and the internet.

The computer system may include a client and a server. The client and server are generally disposed distal from each other and typically interact over a communication network. The relationship between the client and the server is generated by computer programs that run on the corresponding computer and have a client-server relationship with each other.

It should be understood that the steps may be reordered, added or deleted by the various forms of process shown above. For example, the steps in the present disclosure may be performed in parallel or sequentially or in a different order, as long as the desired result of the technical solution disclosed in the present disclosure can be achieved, which is not limited herein.

The aforesaid embodiments do not constitute a limitation on the protection scope of the present disclosure. Those skilled in the art shall understand that various modifications, combinations, sub-combinations and substitutions may be made according to design requirements and other factors. The modification, equivalent replacement, improvement, or the like made according to the spirit and principle of the present disclosure shall be regarded as within the protection scope of the present disclosure.

1. A method of neural network-based operation, comprising:
acquiring an original image, and calculating a total number of operation cycles and an image matrix corresponding to each of the operation cycles from dimensions of a convolution kernel and dimensions of the original image, the image matrix comprising image data in multiple rows and columns;
acquiring, for the image matrix corresponding to each of the operation cycles, the image data by a plurality of operation units in parallel according to an operation instruction, and performing multiplication operations on pre-stored weight data and the image data to acquire intermediate data;
summing intermediate data output by the plurality of operation units to acquire an operation result corresponding to each of the operation cycles; and
gathering all operation results for the total number of operation cycles to acquire a target operation result.

2. The method according to claim 1, further comprising:
determining a weight matrix based on the dimensions of the convolution kernel, wherein the weight matrix comprises weight data in multiple rows and columns, and the convolution kernel has a height equal to the number of rows of the weight matrix and has a width equal to the number of columns of the weight matrix; and
pre-storing by the plurality of operation units the weight data in corresponding rows of the weight matrix respectively.

3. The method according to claim 2, wherein acquiring, for the image matrix corresponding to each of the operation cycles, the image data by the plurality of operation units in parallel according to the operation instruction comprises:
acquiring, for the image matrix corresponding to each of the operation cycles, the image data in corresponding rows of the image matrix according to the operation instruction by the plurality of operation units respectively.

4. The method according to claim 2, wherein acquiring, for the image matrix corresponding to each of the operation cycles, the image data by the plurality of operation units in parallel according to the operation instruction comprises:
changing, for the image matrix corresponding to a current operation cycle, one element of each row of the image data, with the changed image matrix serving as an image matrix corresponding to a next operation cycle; and
acquiring, for the image matrix corresponding to the next operation cycle, changed image data in corresponding rows by the plurality of operation units, respectively.

5. The method according to claim 1, wherein the plurality of operation units form operation unit groups, and the dimensions of the convolution kernel comprise the number of input channels which is same as the number of the operation unit groups.

6. An apparatus for neural network-based operation, comprising:
an image matrix calculating module configured to acquire an original image, and calculate the total number of operation cycles and an image matrix corresponding to each of the operation cycles from dimensions of a convolution kernel and dimensions of the original image, the image matrix comprising image data in multiple rows and columns;
a multiplication operation module configured to acquire, for the image matrix corresponding to each of the operation cycles, the image data by a plurality of operation units in parallel according to an operation instruction, and perform multiplication operations on pre-stored weight data and the image data to acquire intermediate data;
a summation operation module configured to sum intermediate data output by the plurality of operation units to acquire an operation result corresponding to each of the operation cycles; and
a target operation result generating module configured to gather all operation results for the total number of operation cycles to acquire a target operation result.

7. The apparatus according to claim 6, further comprising:
a weight matrix determining module configured to determine a weight matrix based on the dimensions of the convolution kernel, wherein the weight matrix comprises weight data in multiple rows and columns, and the convolution kernel has a height equal to the number of rows of the weight matrix and has a width equal to the number of columns of the weight matrix; and
a weight data storing module configured to pre-store by the plurality of operation units the weight data in corresponding rows of the weight matrix respectively.

8. The apparatus according to claim 7, wherein the multiplication operation module comprises:
a first data acquiring submodule configured to acquire, for the image matrix corresponding to each of the operation cycles, the image data in corresponding rows of the image matrix according to the operation instruction by the plurality of operation units respectively.

9. The apparatus according to claim 7, wherein the multiplication operation module comprises:
a data changing submodule configured to change, for the image matrix corresponding to a current operation cycle, one element of each row of the image data, with the changed image matrix serving as an image matrix corresponding to a next operation cycle; and
a second data acquiring submodule configured to acquire, for the image matrix corresponding to the next operation cycle, changed image data in corresponding rows by the plurality of operation units, respectively.

10. The apparatus according to claim 6, wherein the plurality of operation units form operation unit groups, and the dimensions of the convolution kernel comprise the number of input channels which is same as the number of the operation unit groups.

11. An electronic device, comprising at least one processor and a memory communicatively connected to the at least one processor,
wherein the memory has stored thereon instructions executable by the at least one processor, such that the instructions, when executed by the at least one processor, cause the at least one processor to perform the method according to claim 1.

12. A non-transitory computer readable storage medium having computer instructions stored thereon, wherein the computer instructions are configured to cause a computer to perform the method according to claim 1.
